(19) United States
(12) Patent Application Publication
(10) Pub. No.: US 2024/0159894 A1
(43) Pub. Date: May 16, 2024

(54) RADIO-OPTICAL SENSOR SYSTEM FOR ENVIRONMENT DETECTION

(71) Applicant: Volkswagen Aktiengesellschaft, Wolfsburg (DE)

(72) Inventors: Heiko Gustav Kurz, Hannover (DE); Christoph Scheytt, Dorsten (DE); Marc-Michael Meinecke, Sassenburg (DE); Stephan Kruse, Paderborn (DE)

(21) Appl. No.: 18/508,916

(22) Filed: Nov. 14, 2023

(30) Foreign Application Priority Data
Nov. 16, 2022 (DE) 102022212165.1

(51) Int. Cl. G01S 13/931

(52) U.S. Cl. CPC G01S 13/931; G01S 2013/9315

(57) ABSTRACT

A sensor system for surrounding area detection for a motor vehicle, including an optical device for generating an optical transmission signal, and a transmitter device having: an optical input configured for receiving the optical transmission signal, a radio-based transmitter unit configured for emitting an electrical emitted signal, based on the optical transmission signal, and an optical transmitter unit configured for emitting an optical emitted signal which is based on the transmission signal. The sensor system also may include a receiver device having: an optical input configured for receiving the optical transmission signal, a radio-based receiver unit for receiving an electrical received signal, and an optical receiver unit for receiving an optical received signal. A central computing device is configured for processing emitted and/or received signals.

### RELATED APPLICATIONS

The present application claims priority to German Pat. App. No. DE 10 2022 212 165.1, filed Jul. 16, 2021, to Gustav, et al., filed on Nov. 16, 2022, the contents of which being incorporated by reference in its entirety herein.

### TECHNICAL FIELD

The present disclosure relates to a sensor system for surrounding area detection. Furthermore, the present disclosure relates to a motor vehicle comprising a corresponding sensor system.

### BACKGROUND

For example, EP 1 768 264 B1 discloses a radio oscillation device and a radar device. Here, for example, an optically supported radar system is used.

Furthermore, EP 3 069 411 B1 discloses a high-performance, compact RF receiver for space applications. Here, in particular, a compact, photonic RF receiving system for space- and sky-based applications may be used. This system may, for example, have a laser source for generating a laser light.

For example, DE 10 2018 216 809 A1 discloses a method for surrounding area detection for a vehicle. Here, a first piece of surrounding area information can be detected by means of a first detection device and a second piece of surrounding area information can be detected with a second detection device. The first surrounding area information and the second surrounding area information represent information about at least one object in the surrounding area that can be received from a surrounding area of the vehicle.

### SUMMARY

Aspects of the present disclosure are directed to carrying out a surrounding area detection, in particular for a motor vehicle, more efficiently while reducing the power loss of a system for surrounding area detection.

Some aspects are described in the independent claims recited below. Further aspects are described in the corresponding dependent claims.

In some examples, a sensor system for surrounding area detection is disclosed, the sensor system comprising an optical device for generating an optical transmission signal, and a transmitter device. The transmitter may include an optical input configured for receiving the optical transmission signal, a radio-based transmitter unit configured for emitting an electrical emitted signal based on the optical transmission signal, and an optical transmitter unit different from the radio-based transmitter unit, the optical transmitter unit being configured for emitting an optical emitted signal based on the optical transmission signal. The sensor system may also include a receiver device, the receiver device having: an optical input configured for receiving the optical transmission signal, a radio-based receiver unit for receiving an electrical received signal, and an optical receiver unit for receiving an optical received signal. A central computing device may be configured for processing emitted and/or received signals.

The present disclosure also includes further developments of the sensor system including a motor vehicle having features as described herein, including embodiments of the transmitter device. For this reason, the corresponding further developments of the sensor system according to the invention and the motor vehicle are not described here for the purposes of brevity.

The invention also comprises the combination of the features of the embodiments described.

### DESCRIPTION OF THE DRAWINGS

Aspects of the present disclosure are described in the figures below and the corresponding Detailed Description. The following figures show:

FIG. 1 is a schematic illustration of a motor vehicle having a sensor system, according to some aspects of the present disclosure;

FIG. 2 is a schematic illustration of an embodiment of the sensor system from FIG. 1, according to some aspects of the present disclosure;

FIG. 3 is another schematic illustration of an embodiment of the sensor system from FIG. 1, according to some aspects of the present disclosure;

FIG. 4 is another schematic illustration of an embodiment of the sensor system from FIG. 1, according to some aspects of the present disclosure;

FIG. 5 is another schematic illustration of an embodiment of the sensor system from FIG. 1, according to some aspects of the present disclosure;

FIG. 6 is another schematic illustration of an embodiment of the sensor system from FIG. 1, according to some aspects of the present disclosure; and

FIG. 7 is another schematic illustration of an embodiment of the sensor system from FIG. 1, according to some aspects of the present disclosure.

### DETAILED DESCRIPTION

The exemplary embodiments described below are preferred exemplary embodiments of the invention. In the exemplary embodiment, the described components each represent individual features of the present disclosure which are to be considered independently of each other and which are to be considered independently of each other and are thus also to be regarded as a part of the present disclosure individually or in a combination other than that shown. Furthermore, the described exemplary embodiments can also be supplemented by further of the already described features of the present disclosure.

In the figures, functionally identical elements are each provided with the same reference signs.

In the following, the present disclosure will be described in more detail with reference to the figures. It should be noted that different aspects are described, each of which may be used individually or in combination. That is, any aspect may be used with different embodiments of the invention unless explicitly shown as a pure alternative.

Furthermore, for the sake of simplicity, only one entity will be referred to in the following. However, unless explicitly noted, the invention may also have several of the entities concerned in each case. In this respect, the use of the word “a” is to be understood only as an indication that at least one entity is used in a simple embodiment.

Insofar as methods are described hereinafter, the individual steps of a method can be arranged and/or combined in any order, unless the context explicitly indicates otherwise. Furthermore, the methods can be combined with each other—unless explicitly stated otherwise.

Information with numerical values is generally not to be understood as exact values, but also include a tolerance of +/−1% up to +/−10%.

References to standards or specifications are to be understood as references to standards or specifications which apply/applied at the time of filing and/or—insofar as priority is claimed—at the time of the priority application. However, this is not to be understood as a general exclusion of applicability to subsequent or superseding standards or specifications.

In the sensor system described herein, radio-based measuring systems and optics-based measuring systems can be combined in one system. By combining the radio-based units and the optics-based units in the sensor system, different measuring systems or and/or measuring principles can be joined or combined. This has particular advantages when using surrounding area detection in motor vehicles. By combining or using different measuring principles, in particular for surrounding area detection, a more efficient and, in particular, improved surrounding area detection can be performed, since different measuring principles can be advantageously combined, and thus used, in one system.

For example, a sensor system according to the present disclosure can be used to combine an electrical measuring system such as radar and an optical measuring system such as LIDAR into one measuring system or detection system. This makes it possible, for example, to use a single drive and evaluation unit for the combined system or sensor system as compared to the present state of the art. This makes it possible to reduce power losses during driving and/or data processing in particular. Thus, a surrounding area detection can be performed in a more energy-efficient manner. Furthermore, combined data processing of, for example, a coherent LIDAR signal relating to the optics-based unit, and a radar signal (e.g., from a radio-based unit), allows more information to be evaluated than if these signals were preprocessed independently and then combined, for example, with sensor fusion. Furthermore, the combined sensor system according to the present disclosure offers the possibility to compensate for limitations of one sensor technology, such as bad weather and contamination, with the other sensor technology. Thus, a surrounding area detection can be performed in a more secure manner.

Furthermore, it is possible to place both measuring principles simultaneously into a 1D array, 2D array and/or 3D array and to focus the measurements in the same spatial area or at least in close proximity to each other. The optional use of optimized lenses and/or combination of lenses can focus the EM rays or the light even more strongly into a spatial area. Thus, the two different measuring principles or measuring systems can be advantageously combined, especially for the detection of a vehicle's environment, in order to gain added value, particularly with regard to detected objects in the environment, especially through additional independent measurement variables and their information.

Conventionally, electrical and optical measuring systems are used independently of each other, so that they work independently of each other. These systems thus each need a dedicated drive circuit and evaluation circuit, which leads to increased power loss of these systems. This can be solved or improved with the transmitter device configurations disclosed herein. This increases the battery runtime, in particular, in the area of electro mobility, which is also advantageous for a motor vehicle.

For example, a radar circuit or a LIDAR circuit can be arranged in a fully populated and/or in a partially populated 1D array, 2D array and/or 3D array so that a refined angular resolution can be achieved. For this purpose, the transmitter unit, receiver unit and/or the transmitter/receiver unit can be spatially separate from each other. Among other things, the result of this separation is that during the independent preprocessing of the two signals of the measuring units with subsequent sensor fusion, as in the prior art, relevant data can be lost and, for example, is therefore not available. The sensor system can be used to join these different measuring systems or measuring principles together to a combined measuring system to solve and/or at least minimize the problem described above. Furthermore, to date, LIDAR systems and radar systems are not operated coherently which makes combined data processing more difficult. The sensor system configurations disclosed herein can be used to create a coherent radar/LIDAR system, which may lead to improved data processing.

Furthermore, the sensor system configurations disclosed herein may eliminate the need for independently operating radar systems and LIDAR systems. Thus, drive circuits, signal processing circuits and/or further hardware and/or software components, such as a sensor fusion device, of the individual systems can be omitted. Accordingly, the power loss of a sensor system that combines at least two measuring principles and/or measuring systems can be reduced by means of the technologies and techniques of the present disclosure. Furthermore, the signals relating to the radio-based unit and the optics-based unit can be processed together. This can improve information relating to a surrounding area detection and/or of a detected object in the environment. This has advantages especially for use in autonomously operated vehicles. Furthermore, the radio-based unit and the optics-based unit can be configured to be mutually coherent.

The radio-based transmitter and receiver unit can be a unit or combination unit and/or a device or combination device which carries out the detection of an object and/or the surrounding area by means of radio-based electrical and/or electromagnetic signals. For example, the radio-based unit can be a radar unit. The optics-based transmitter and/or receiver unit can be a unit and/or a device which carries out the detecting of an object and/or a surrounding area by means of optical signals, e.g., the light of a laser and/or light transmitter diodes (LEDs). For example, the optical unit and/or device can be a LIDAR unit.

If suitable, the optical emitted signal and/or the electrical emitted signal can correspond to the optical transmission signal.

Specifically, spectral characteristics of the optical transmission and/or received signal can be the same as the electrical transmission and/or received signal. For example, the optical source or the optical device can generate a 77 GHz FMCW signal. This signal can then be used for FMCW LIDAR as well as for 77-GHz radar. If both emitted signals are reflected by the same object and the radar cross-section and the LIDAR cross-section are the same, both also receive the same signal.

For example, at least one optical device may be provided, wherein the optical signal of the optical device can be modulated directly and/or by means of external components.

Furthermore, the computing device may have electrical and/or optical receivers.

If desired, both sensor signals, i.e., the emitted and received signals can be processed together, in particular, by means of the computing device.

The units of the sensor system may be realized from individual chips, from an interconnection of chips, by means of discrete components and/or an interconnection of chips with discrete components. A wide variety of technologies, such as (heterojunction) bipolar transistors and CMOS, and materials, such as SiGe(:C), Si₃N₄, SOI, InGaS and InP, can be used.

With the sensor system according to the present disclosure, the aforementioned detection principles or measuring principles can be used together to better and, in particular, more efficiently detect objects in the environment, for example, in an environment of a motor vehicle. This has the further advantage that the computing device is configured to be used as a common signal processing unit and/or evaluation unit for both LIDAR and radar. This means that additional computing or evaluation units are not needed.

The joint processing or evaluation of the radar signal and the LIDAR signal allows the sensor system to be operated more efficiently and, in particular, to operate with less power loss than two discrete radar and LIDAR measuring systems. Thus, the sensor system can be advantageously used in motor vehicles, in particular, in autonomously operated motor vehicles, since the sensor system has a smaller package volume, fewer losses and at the same time improved detection capability or sensing capability.

In some examples, a coherent radar/laser measuring system or radar/LIDAR measuring system can be created with the sensor system.

The data, signals and information can be centrally processed in a central computing device.

In some examples, a radio-based transmitter unit is configured to generate and emit the electrical emitted signal in dependence on the optical transmission signal and/or to generate and emit the electrical emitted signal based on a manipulation of the optical transmission signal. Furthermore, the optical transmitter unit may be configured to directly emit the optical transmission signal as the optical emitted signal, or to convert the optical transmission signal to the optical emitted signal through manipulation and emit it.

For example, the electrical emitted signal, which is optionally based directly on the optical transmission signal or is optionally generated through manipulation of the optical transmission signal, can be emitted by means of the radio-based transmitter unit.

With the optical transmitter unit, which is different from the radio-based transmitter unit, the optical emitted signal, which is, for example, based directly on the optical transmission signal or is generated through manipulation of the optical, can be emitted.

In addition, an optical-electrical conversion device, e.g., a photodiode and/or a phototransistor, can be used to generate the electrical emitted signal as in dependence on the optical transmission signal. In particular, the optical-electrical conversion device may be arranged on or integrated and/or partially integrated in the system.

Furthermore, a monitoring unit for monitoring the conversion process of the optical transmission signal to the electrical emitted signal may additionally be provided. The monitoring unit can be used for diagnostic purposes.

In some examples, the optical-electrical conversion unit can be referred to as a detector.

In some examples, the receiver device may be configured with a first optical output and/or a first electrical output configured for providing the optical received signal to the central computing device. Furthermore, the receiver device may have a second optical output and/or a second electrical output configured for providing an optical output signal, which is based on the electrical received signal, to the central computing device. For example, the receiver device may have an optical input configured for receiving the optical signal of the optical device. In particular, an optical receiver unit, which is different from the radio-based receiver unit and from the optical input and configured for receiving an optical signal, may be provided. Thus, by means of the optical and/or electrical outputs, which are coupled to the computing device via corresponding lines, for example, the respective signals can be transferred to the computing device for evaluation or processing, in particular for surrounding area detection.

The optical signals can be transferred or transmitted via optical connection paths such as fiber optics and/or via open-space propagation. The electrical signals can be transferred to the computing device via electrical lines.

In an exemplary embodiment, it is provided that the receiver device has an optical and/or electrical amplifier and/or an optical demodulator and/or an electrical demodulator. The optical received signal can be amplified by means of the optical amplifier. The electrical received signal can be amplified with the electrical amplifier.

The optical and/or electrical demodulator can be used to recover a useful signal, such as the transmission signal, in the baseband that was previously modulated onto a carrier by modulation. Specifically, an in-phase quadrature-phase (I&Q) method can be performed, whereby phase information can be obtained when a high-frequency carrier signal is demodulated.

In some examples, the receiver device may be configured with an electrical return channel and/or an optical return channel, the receiver device being coupled with the optical device via the electrical return channel and/or the optical return channel. Thus, the optical transmission signal can be provided to the receiver device. With the optical return channel, the light from the optical device can be reused for the return channel. The receiver device may additionally and/or instead have a dedicated optical source for the optical return channel.

The optical return channel of the receiver device may be supplied by the optical transmission signal of the optical device and/or that the receiver device has a further optical source coupled to the optical return channel.

In some examples, the central computing device may be configured with an interface with an external signal processing unit and/or that a signal processing unit is integrated in the central computing device. Depending on the application or field of use of the sensor system, signal processing and thus surrounding area detection can be performed by the computing unit itself or externally by another unit.

In some examples, the transmitter device, the receiver device, the optical device and the central computing device may be configured with physically and/or spatially separate entities with respect to each other. Consequently, the devices are separate units with respect to each other or from each other. Alternatively, the transmitter device, the receiver device, the optical device and the central computing device may be configured as a joint unit. Consequently, the devices are a combined, joined or single unit. For example, the devices can be integrated together on one chip. This has, in particular, space-saving and space-optimized advantages.

If desired, the transmitter device and/or receiver device can be spatially separate from each other as well as from the optical device. In this case, an optical transmission path is specifically required.

In some examples, the transmitter device, the receiver device, the optical device and the central computing device may be configured to be at least partially physically and/or spatially separate entities with respect to each other. Thus, the sensor system can be better adapted to the respective field of application or to the respective use case.

For example, the transmitter device, the receiver device and the optical device can be formed together as a joint unit and be physically and/or spatially separate as a joint unit from the computing device. It is also conceivable that the transmitter device, the receiver device and the computing device are formed together as a joint unit and are physically and/or spatially separate as a joint unit from the optical device. Furthermore, it is conceivable that the transmitter device and the receiver device are formed together as a joint unit and are physically and/or spatially separate as a joint unit from the optical device and from the computing device. It is also conceivable, that the optical device and the computing device are formed as a joint unit, and the joint unit, the transmitter device and the receiver device are physically and/or separate units with respect to each other.

The aforementioned possibilities as to how the individual devices are designed in relation to each other are not to be understood as conclusive and limited, but are merely intended to provide an overview of some combination possibilities. Further combinations are therefore possible. In this context, it should be mentioned that the arrangement of the hardware components is not to be understood conclusively, but merely to provide an overview of the most diverse possible combinations. Further combinations of the hardware components are thus also possible.

In some examples, a motor vehicle is disclosed, configured with a sensor system according to present disclosure. The motor vehicle may be configured with an assisted or at least partially autonomously operated vehicle. In particular, the motor vehicle is a highly automated motor vehicle which includes various driver assistance systems. These driver assistance systems can make use of the proposed sensor system and, for example, retrieve surrounding area information. In particular, the motor vehicle may have several such sensor systems or transmitter devices.

The motor vehicle may be configured as a motor vehicle, such as a passenger car or truck, or as a passenger bus or motorcycle. In addition, streetcars, subways, railroads, boats, aircraft, satellites and other mobile units can also be equipped with this sensor technology.

For example, the units of the sensor system can be arranged in a distributed manner on the motor vehicle, in particular, for surrounding area detection. In particular, the sensor system can be a surrounding area detection system.

In particular, the sensor system can be used for surrounding area detection or detection of objects or environmental pollution. The sensor system may have the transmitter device described herein and the sensor system may comprise a plurality of transmitter devices.

The central electronic-photonic computing device can be used to control the transmitter device or provide it with the optical transmission signal. In particular, the central electronic-photonic computing device or central electronic computing device can be used as a drive and evaluation unit of the sensor system and for the transmitter device and for the receiver device. Accordingly, a wide variety of transmitter devices and/or receiver devices can be controlled or operated or driven with one and the same central electronic-photonic computing device.

The central electronic-photonic computing device may be configured as a physically separate unit that is different from the transmitter device and/or receiver device. In particular, the electronic-photonic computing device is not necessarily a component of the one-chip system of the transmitter device. In comparison to the one-chip system of the transmitter device, the central electronic-photonic computing device can be a different semiconductor chip or integrated circuit or an interconnection of semiconductor chips or integrated circuits.

For example, the central electronic-photonic computing device can be used to perform tracking of an FMCW signal and an optical signal, as well as overall signal processing and signal evaluation.

In some examples, the central electronic-photonic computing device can be coupled to the optical input and the optical output via one or more fiber optics. Consequently, the optical transmission signal generated by the central electronic-photonic computing device is coupled into the fiber optics and transmitted to the optical input of the emitting device via optical signal transmission. The fiber optics may be, for example, a fiber optic line. The sensor system may be configured as a coherent radar/laser measuring system. In particular, the proposed sensor system enables a combination of a radar sensor and a LIDAR sensor in one detection unit, in particular, for vehicle.

For example, the receiver device may be configured as a further, dedicated one-chip system. Thus, in an analogous manner to the transmitter device, all components or parts of the receiver device can be integrated or arranged on a single chip, i.e., on the one-chip system. Thus, the computing device, the transmitter device and the receiver device can each be a discrete dedicated integrated circuit that is separate from the others.

Another conceivable variant is that the receiver device is integrated in the transmitter device. Thus, the receiver device can additionally be integrated on the one-chip system of the transmitter device. This has space-saving and space-optimized advantages. Accordingly, all components or parts for receiving and emitting signals can be integrated on the one-chip system. The computing device again is discrete. In this combination device, a combined transmitting/receiving antenna and/or a subassembly of transmitting/receiving antennae can be interconnected to a transmitting/receiving array.

In some examples, the receiver device is a radio-based receiver unit for receiving an electrical received signal corresponding to the electrical emitted signal and reflected in the environment and an optics-based receiver unit for receiving an optical received signal corresponding to the optical emitted signal and reflected in the environment. The receiver device is thus configured for receiving the signals of the transmitter device emitted by the radio-based transmitter unit and the optics-based transmitter unit.

The radio-based transmitter unit can be used to emit the electrical emitted signal into an environment, in particular, into the environment of a motor vehicle. This emitted electrical emitted signal can be reflected by an object in the environment or within the environment. The electrically emitted signal can be received by means of the radio-based receiver unit, which may be a receiving antenna. In particular, the radio-based receiver unit may be a radar receiving antenna or a radar receiver unit. The optics-based received signal can be received by means of the optics-based receiver unit, which can be a receiver unit of a LIDAR sensor, for example. In particular, the optical received signal corresponds to the optical emitted signal.

For example, the electrically received signal and the optically received signal may have been reflected by the same object in the environment. Thus, for example, the detection of an object in the environment of the motor vehicle can be improved. Furthermore, it is conceivable that, on the one hand, a first object is detected with the radio-based transmitter unit and the radio-based receiver unit. Accordingly, the optics-based transmitter unit and the optics-based receiver unit can detect a further object in the environment in addition to this first object. Specifically, it is particularly advantageous when the radio-based detecting or capturing and the optics-based detecting or capturing of objects are combined. Such a combination provides more value to information relating to objects in the environment and thus more detailed information of the environment. This may be advantageous in autonomously operated vehicles in which an efficient sensor system is necessary.

Exemplary embodiments of individual aspects of the present disclosure are to be considered advantageous exemplary embodiments of other aspects, in particular, of all other aspects. In particular, the respective exemplary embodiments of individual aspects can be considered to be advantageous exemplary embodiments of all other aspects and also vice versa.

A surrounding area sensor system can, for example, be understood to be a sensor system that is capable of generating sensor data or sensor signals that map, display, or reproduce the environment of the surrounding area sensor system. In particular, the ability to capture electromagnetic or other signals from the environment is not sufficient to consider a sensor system to be a surrounding area sensor system. For example, cameras, radar systems, LIDAR systems and/or ultrasonic sensor systems can be considered to be surrounding area sensor systems.

A known design of LIDAR systems are so-called laser scanners in which a laser beam is deflected by means of a light deflecting apparatus so that different deflection angles of the laser beam can be realized. The light deflecting apparatus may, for example, include a rotatably mounted mirror. Alternatively, the light deflecting apparatus can have a mirror element with a tiltable and/or pivotable surface. The mirror element can, for example, be configured as a micro-electro-mechanical system, MEMS. The emitted laser beams can be partially reflected in the environment and the reflected portions can in turn strike the laser scanner, in particular the light deflecting apparatus that can direct them to a detection unit of the laser scanner. Each optical detector of the detection unit generates, in particular, an associated detection signal based on the portions detected by the respective optical detector. Based on the spatial arrangement of the respective detector together with the current position of the light deflecting apparatus, in particular, its rotational position or its tilt and/or swivel position, it is thus possible to conclude the direction of incidence of the detected reflected portions. In addition, an evaluation unit can carry out a time-of-flight measurement to determine a radial distance of the reflecting object. Alternatively, or additionally, a method can be used for distance determination according to which a phase difference between emitted and detected light is evaluated.

Other implementations of LIDAR systems include Flash-LIDAR systems. These are non-scanning systems that do not require such a light deflecting arrangement. Here, the laser light generated by the light source is scattered by an optical element so that it is beamed over a wide angle in a single flash.

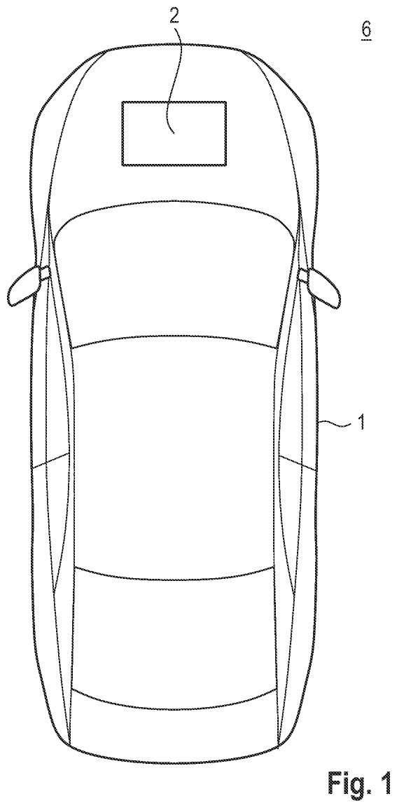

Turning to FIG. 1, the drawing shows a schematic top view of an embodiment of a motor vehicle 1, according to come aspects of the present disclosure.

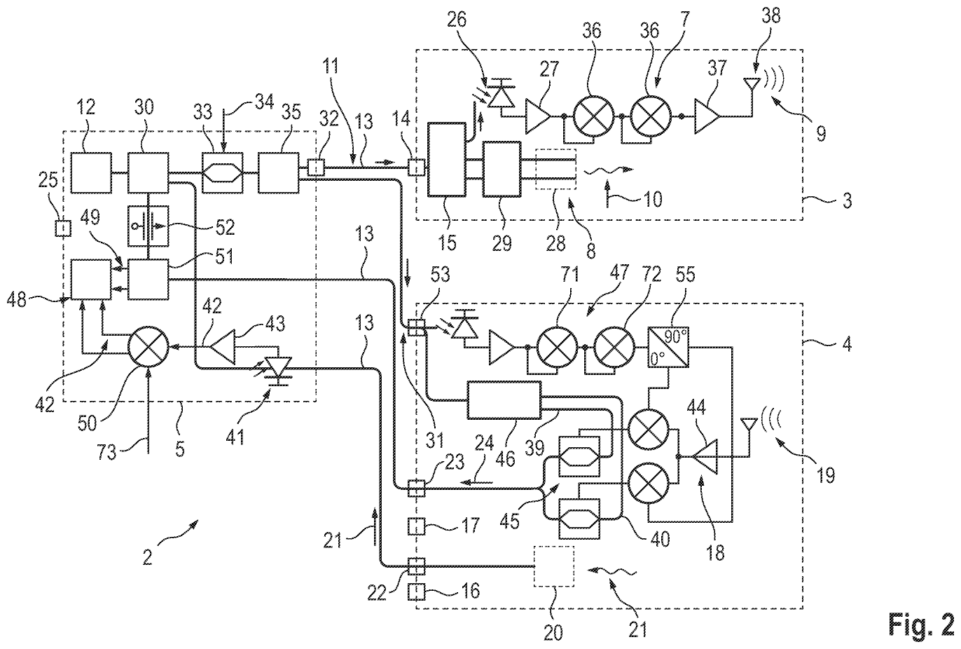

The sensor system 2 has, for example, a transmitter device 3 (c.f. FIG. 2), a receiver device 4 (c.f. FIG. 2) and a central computing device 5 (c.f. FIG. 2).

The motor vehicle 1 may be configured as fully automated vehicle or at least partially autonomously operated vehicle.

The sensor system 2 is used, for example, for surrounding area detection of an environment 6 of a motor vehicle 1. In particular, the sensor system 2 may be a component of a driver assistances system of the motor vehicle 1. In particular, the sensor system 2 provides relevant information, in particular, regarding the environment 6, for the driver assistance system or a vehicle guidance system.

In addition to using the sensor system 2 in the motor vehicle 1, the sensor system 2 may also be used in vehicle-external systems. For example, the sensor system 2 may be used in automated systems, in aerospace technology, in aeronautical engineering or in communications technology. Here in FIG. 1, the example in which the sensor system 2 is integrated in the motor vehicle 1 is shown for illustrative purposes.

FIG. 2 shows by way of example one of several embodiments of the sensor system 2 in an illustration, in particular, a block diagram.

The central computing device 5 may be a discrete and physically separate unit from the transmitter device 3 and/or from the receiver device 4.

In some examples, the transmitter device 3, the receiver device 4, the optical device 12 and the central computing device 5 can be physically and/or spatially separate entities with respect to each other. Alternatively, the transmitter device 3, the receiver device 4, the optical device 12 and the central computing device 5 can be formed together as a joint unit.

In a further embodiment the transmitter device 3, the receiver device 4, the optical device 12 and/or the central computing device 5 can be at least partially physically and/or spatially separate entities with respect to each other.

The central computing device 5 may be, for example, a central unit or a central control unit or central drive unit of the sensor system 2.

The sensor system 2 may be particularly advantageous in that the sensor system 2 combines the measuring principles of a LIDAR sensor and the measuring principles of a radar sensor. In particular the transmitter device 3 and the receiver unit 4 are specifically configured for this purpose.

On the one hand, the transmitter device 3 has a radio-based transmitter device 7 and on the other an optical transmitter unit 8 that is different or differing from the radio-based transmitter unit 7. The radio-based transmitter unit 7, which is based, in particular, on a radar sensor, can be used to emit an electrical emitted signal 9 into the environment 6. The optical transmitter unit 8, which is based, in particular, on a LIDAR sensor, can be used to emit an optical emitted signal 10 into the environment 6. In particular, the transmitter device 3 is configured for emitting the two signals 9, 10 simultaneously or offset to each other. It is particularly advantageous here that the electrical emitted signal 9 and/or the optical emitted signal 10 are based on an optical transmission signal 11. Accordingly, the optical and the electrical emitted signal 9, 10 can be designed to be mutually coherent.

Thus, the transmitter device 3 can be driven by the central computing device 5 such that both a radar-based and a LIDAR-based signal can be emitted. This enables an improved and, in particular, loss-minimized surrounding area detection or environment detection.

The optical device or a laser device 12, that is to say, for example an optical source, can be used to generate the optical transmission signal 11. In the figure shown, the optical device 12 is integrated in the computing device 5, for example. However, this is only one possible example. The optical device can also be designed as an independent unit.

In this example, the optical transmission signal 11 can be transmitted or transferred via fiber optics 13 to an optical input 14 of the transmitter device 3. Thus, the transmitter device 3 and the central computing unit 5 are coupled via an optical transmission path.

The coupled optical transmission signal 11 can be provided or transmitted to the radio-based transmitter unit 7 and the optical transmitter unit 8 via an interface unit 15 of the transmitter device 3.

For example, the interface unit 15 can be referred to as a 1×(N+1) splitter with N∈ [symbol] >1. Thus, the optical transmission signal 11 can be used to control both a radar-based and a LIDAR-based sensor or transmitter unit.

In order to equip or combine the transmitter device 3 with both LIDAR technology and radar technology, all components or parts of the transmitter device 3 can be arranged or mounted on one and the same semiconductor chip or integrated circuit. Thus, a combined integration of the LIDAR technology and the radar technology on one and the same chip or circuit or unit is achieved.

In other words, the transmitter device 3 can be used to combine a radar system and a LIDAR system. By means of the computing device 5 or a central station, the radar system and LIDAR system can have a common control and evaluation device. Furthermore, the radar and LIDAR signals or the radio-based signals and the optics-based signals can be mutually coherent and a combined signal processing for the transmitter units 7, 8 can be provided by means of the computing device 5.

The receiver device 4 can be integrated together with the transmitter device 3, for example, whereby all components relating to the emitting and receiving of signals can be integrated on one unit. As shown in FIG. 2, the transmitter device 3 and the receiver device 4 may also be physically and/or spatially separate units with respect to each other.

It is also conceivable that the receiver device 4 is designed as a separate unit from the transmitter device 3.

The receiver device 4 may be configured with a radio-based receiver unit 18 for receiving an electrical received signal 19 that corresponds to the electrical emitted signal 19 and is reflected in the environment 6. The radio-based receiver unit may be a radar unit or radar antenna. The radio-based transmitter unit 7 and the radio-based receiver unit 19 are complementary to each other. Furthermore, the receiver device 4 may have an optical receiver unit 20. The optical receiver unit 20 can be used to receive an optical received signal 21 which, in particular, corresponds to the optical emitted signal 10 and is reflected or scattered in the environment 6. Optimally, the optical receiver unit 20 is complementary to the optics-based transmitter unit 8. Thus, both optical and electrical signals can be emitted by means of the transmitter device 3 for surrounding area detection or for detecting the environment 6, and when the signals are reflected or backscattered from objects, in particular collision objects, in the environment 6, the signals can be received with the corresponding receiver units 18, 20 of the receiver device 4 and accordingly transferred to the central computing unit 5, which can also be referred to as data processing device, for signal evaluation or signal processing.

For this purpose, the receiver device 4 may have a first optical output 22. The optical output 22 may be coupled or connected to the central computing device 5 via fiber optics 13 so that the received optical received signal 21 can be provided to the computing device 5. Furthermore, the receiver device 4 may have a second optical output 23. The second optical output 23 may also be connected or coupled the computing device 5 via fiber optics 13. The second optical output 23 can be used to transmit an optical output signal 24, which is based on the electrical received signal 19, to the computing device 5. In particular, the receiver device 4 may be configured such that the electrical received signal 19 can be converted to the optical output signal 24.

For example, the receiver device may have, additionally or alternatively to the first optical output 22, 23, a first and second electrical output 16, 17.

For example, the transmitter device 3 has a photodiode 26 with which the conversion of the optical transmission signal 11 to the electrical emitted signal 9 can be carried out.

Additionally, an amplifier unit 27 or a transimpedance amplifier may be provided. The amplifier unit 27 can be used to increase a frequency of the electrical emitted signal 9 generated by the optical photodiode 26 as a function of a specified carrier frequency.

The radio-based transmitter unit 7 may have at least one antenna 28 or several antennae for emitting the electrical emitted signal 9. This is, for example, a radar antenna.

Likewise, to be able to emit the optical emitted signal 10, the optical transmitter unit 8 may have an optical radiation unit 28 such as a laser. A phase shift module 29 (phase shifter) may be provided or arranged between the interface unit 15 and the optical radiation unit 28. The phase shifter module serves primarily to generate the optical emitted signal 10 in dependence on the optical transmission signal 11 through adjustment, manipulation or modification. Thus the optical transmission signal 11 can still be processed or adapted for actual emission.

Hereinafter, the operating principle of the transmitter device 3 is explained again using different exemplary embodiments.

For example, the optical transmission signal 11 or an optical signal can be generated or created by means of the optical device 12, which may also be referred to as optical source, for example. The optical transmission signal 11 can be distributed into any number of paths, for example, by means of a splitter 30 or a 1×M splitter with M∈ [symbol] >1. One path can be used for transmitting the optical transmission signal 11 to the transmitter device 3. In case the laser device 12 is also to be used for an optical return channel 31, one path can be used for the return channel 31. The return channel 31 can be used to transfer or transmit the transmission signal 11 to the receiver device 4 for processing. For this purpose, the receiver device 4 may have a first optical input 53.

Furthermore, the receiver device 4 may have an electrical return channel additionally to or instead of the optical return channel 31.

For example, a modulating device 33 may be arranged between the optical device 12 and an optical output 32 of the computing device 5. The modulating device 33 can be used to modulate the optical transmission signal 11 with a carrier signal 34. Thus, the optical transmission signal 11, which is provided via a path, can be modulated with one or several signals by means of one or several electro-optical modulators and split. This is done in particular before the optical transmission signal 11 is transmitted or distributed to the transmitter device 3 and/or receiver device 4. For example, the transmitter device 3 can be referred to as transmitter frontend of the sensor system 2. The receiver device 4 can be referred to, for example, as receiver frontend of the sensor system 2. Furthermore, with multiple modulation, further optical dividers and combiners may be provided upstream and downstream of the electro-optical modulator or modulation device 33. For example, a further splitter 35 may be provided between the modulating device 33 and the optical output 32. The splitter may be, for example, a 1×2 splitter.

The illustrated exemplary arrangement or positioning of the splitter 30 and the modulating device 33 can be changed or adjusted based on the use case.

The interface unit 15 can be used to divide or split the transmission signal 11 depending on the number of transmitter units 7, 8.

For example, the radio-based transmitter unit 7 may be part of a radar emission path of the transmitter device 3. The optical transmitter unit 8, in turn, may be a component of a LIDAR emission path.

For example, the optical transmission signal 11 may be modulated with a carrier signal 34, for example a FMCV signal. This modulated signal, i.e., also the modulated transmission signal 11, can be converted into the electrical emitted signal 9 by means of an optical-electronic converter or a photodiode 26 or a phototransistor. The amplifier unit 27 (TIA) can be used to adjust the electrical emitted signal 9 in such way that a parasitic capacitance of the photodiode 26 does not determine the total bandwidth. For example, the electrical emitted signal 9 can furthermore be mixed up to a higher frequency by means of a frequency multiplier 36 or several frequency multipliers. If there are any other modulated signals, these signals can also be multiplied by the signal of the transmission frequency. The signal can in turn be amplified by means of a power amplifier 37 and emitted or radiated by the transmitting antenna or antenna 38.

For example, the antenna 38 may itself have directivity or a larger number of transmitter units, i.e., radio-based transmitter units, may produce directivity by superposing the radiated waves from the individual transmitting units.

Furthermore, the radio-based transmitter unit 8 or a LIDAR-TX matrix may be integrated on the transmitter device 3. Here, the phase of the optical transmission signal 11 can be manipulated by means of the phase shift module 29 such that superposing the radiated power or the optical emitted signal 10 illuminates a desired spatial area, in particular, in the environment 6. When using several optics-based transmitter units, phase modulation or phase shifting can be dispensed with, since the illumination of a spatial area in the environment 6 can be realized by superposing the emitted signals of several transmitter units. By jointly driving the radio-based transmitter unit 7 and the optics-based transmitter unit 8 with an optical signal, i.e., the optical transmission signal 11, the transmitting units 7, 8 exhibit frequency coherence and phase coherence. Accordingly, a LIDAR/radar system, i.e., the sensor system 2 can be created, which is both frequency coherent and phase coherent.

In the receiver device 4, the optical transmission signal 11 provided via the return channel 31 can be separated into two to three paths. In this example, the transmission signal 11 is split into a first path 39 and a second path 40. In the case of a split into three paths, the LIDAR RX signal or the received optical receive signal 21 can be superposed with one of the paths 39, 40 in a coupler. In this case, the path from the splitter 30 to the opto-electronic converter 41 of the central computing device 5 can be omitted. The converter 41 may be a photodiode or a phototransistor.

In the case of a split into two paths 39, 40, the optical received signal 21 can be converted to an electrical LIDAR signal 42 or an electrical signal by means of the opto-electronic converter 41. Furthermore, for this purpose, an amplifier 43 may optionally be provided. In particular, by means of the amplifier 43, the optical received signal 41 can be converted into a voltage signal and amplified. For example, the electrical received signal 19 can be amplified by means of a further amplifier 44 so that the received signal is, for example, mixed up to a signal with a higher frequency. For example, the amplifier 44 can be configured as a LNA (Low Noise Amplifier). For example, the electrical received signal 19 can be optically converter to the optical output signal 24 by means of an optical IQ modulator 45. In this case, the optical transmission signal 11 provided by means of the return channel 31 can be considered. For this purpose, an optical IQ generator 46 may be provided in the return channel 31, for example.

In some examples, the optical receiver may be realized as a single element or as a matrix with additional phase shifters and optical combinations. In addition to or instead of using an additional processing path 47, the received electrical received signal 19 can be appropriately modified and converted into an optical signal to make the optical signal available to the computing device 5. The processing path 47 may have two mixers 71, 72 and a 0°/90° divider 55.

In the case of an IQ signal, for example, a second channel of the splitter 30 can be used in the computing device 5 for self-coherent detection after prior phase adjustment. After digitization, the demodulated and electrically converted signal can be processed in an evaluation unit or signal processing unit 48 together with the received signal of the LIDAR system. The electrically converted signal may be an electrical radar signal 49 that is based on the electrical received signal 19. The received signal of the LIDAR system may be the electrical LIDAR signal 42. Thus, the evaluation unit may be a signal processing unit or signal evaluation unit of the sensor system 2 which is configured as a radar/LIDAR system.

For example, the computing device 5 may directly have the signal processing unit 48. Otherwise, the signal processing unit 48 may be configured externally to the computing device 5 and the computing device 5 may have an interface 25 with which the computing device 5 can be coupled to the signal processing unit 48.

For example, an IQ mixer 50 may be provided with which the electrical LIDAR signal 42 can be modulated or mixed. In this case, for example, a carrier signal 73 can be used again. The carrier signal 73 may correspond to the carrier signal 34. Furthermore, the optical output signal 24 can be converted or demodulated to the electrical radar signal 49 by means of a demodulating unit 51 or a SC-IQ radar demodulating unit. Furthermore, for the detection of the LIDAR signal 42, a third path of the splitter 30, provided that the LIDAR signal 42 has not been superposed with the transmission signal 11, can be made available to an opto-electronic converter 52 together with the optical received signal 21 and, if necessary, amplified if and before it is demodulated with an IQ mixer, if present, or demodulated with the unit 51. This demodulated signal is also digitized and made available to the evaluation unit 48.

By means of the sensor system 2, a radar-LIDAR system can be combined depending on the computing device 5 and therefore have a common driving device and evaluation device. Furthermore, a LIDAR and radar transmitter unit and/or a LIDAR and radar receiver unit may be located on a system and an integrated chip. In particular, the transmitter units 7, 8 can be driven such that the respective transmitting lobes or emitting areas can be focused simultaneously on a spatial area in the environment 6. Furthermore, the radar and LIDAR signals can be mutually coherent and thus the signal processing can be combined. In the signal processing, this combination leads to obtaining a vector containing the inputs of the radar and the LIDAR system. The remaining parts of the vector can be filled with zeros, resulting in a vector of the form [radar data, 0, 0, . . . , 0, 0, LIDAR data]. The added zeros result in more sidelobes in a subsequent Fourier transform. Here, a sharper peak can be used at the desired locations. Furthermore, the LIDAR signals can be generated in several ways coherent to the radar signals. Due to optical frequency and phase coherence of the optical sources, this may cause coherent generation of one or more optical sidelobes, and coherent polarization changes of the optical signal. Such mathematical matching of the system of equations can in turn be used to both increase the SNR (signal-to-noise ratio) and reduce the magnitude of the side lobe.

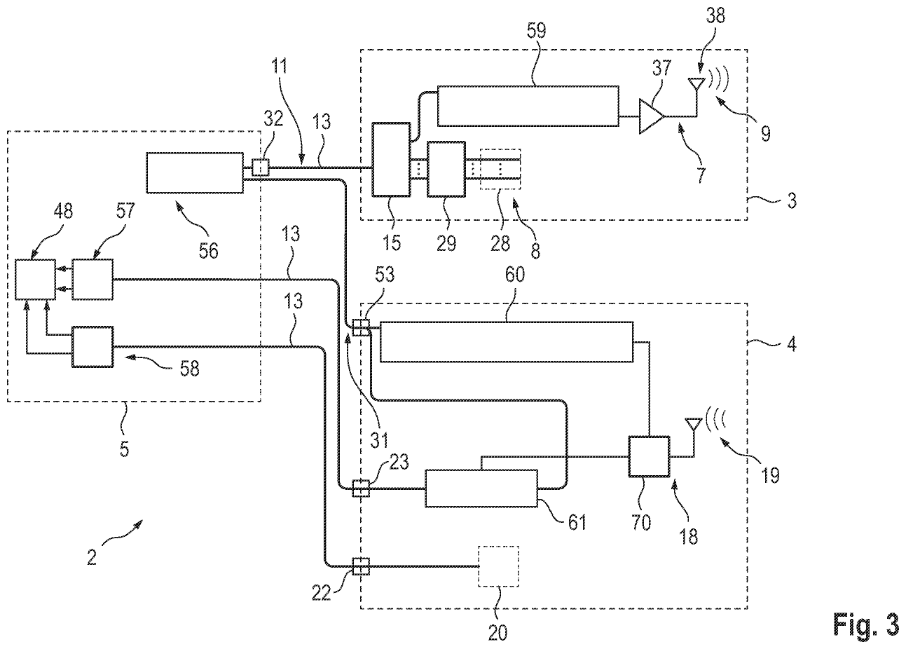

FIG. 3 shows by way of example another conceivable embodiment of the sensor system 2, in particular, in a block diagram. The previously described explanations regarding the sensor system 2 and its components also apply. Here, the computing device 5 can, for example, have an optical signal generating device 56 for signal generation of the signal 11. The optical signal generating device 56 may have the optical device 12, the splitter 30, the modulating device 33 and/or the further splitter 35, if desired. Optionally, the demodulating device 51 and the opto-electronic converter 52 can be combined to a unit 57. With the unit 57, a coherent, in particular, a self-coherent detection can be carried out. The unit 57 may be used for the opto-electronic conversion of signals such as a radar signal and for demodulation. For example, the opto-electronic converter 41, the amplifier 43 and/or the IQ mixer 50, can be combined to a unit 58. The unit 58 may optionally also be arranged in the receiver device 4. The unit 58 is, in particular, used for the opto-electronic conversion of signals such as a LIDAR signal and for demodulation. Furthermore, it is conceivable that the photodiode 26, the amplifier unit 27 and/or the frequency multiplier 36 are combined to an opto-electronic converter unit 59. Specifically, the opto-electronic converter unit 59 can be used for signal manipulation. Optionally, the receiver device 4 may have an opto-electronic converter unit 60 which, for example, can be used for demodulation. The opto-electronic converter unit 60 may have the IQ modulator, IQ generator, the additional signal processing path 47, the divider 55, the mixer 71 and/or the mixer 72. Furthermore, the receiver device 4 may have a further opto-electronic converter unit 61. The further opto-electronic converter unit may be used instead of the IQ modulation 45. Furthermore, a radar-based receiver unit 70 may be provided.

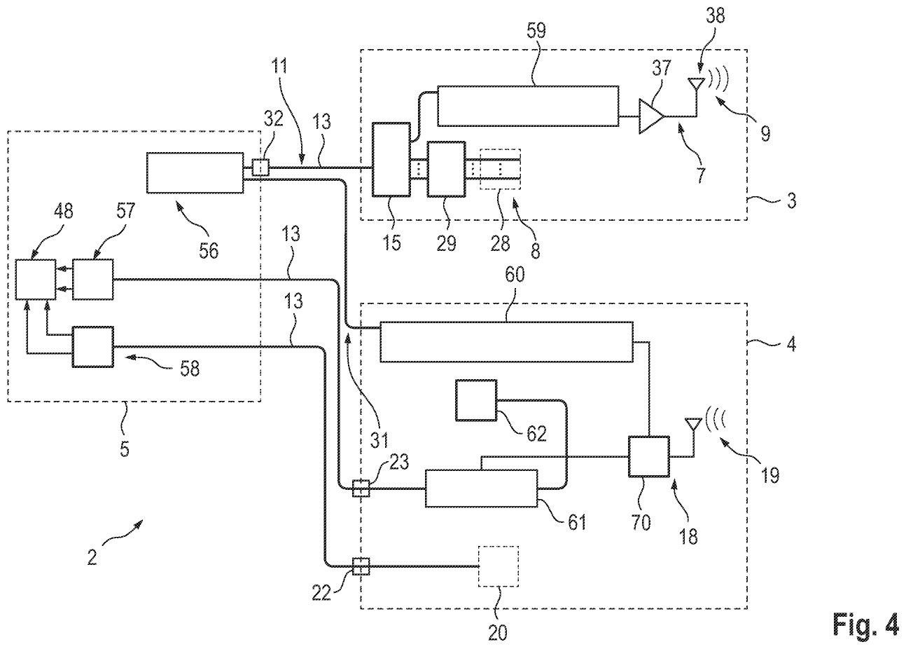

FIG. 4 shows by way of example another conceivable embodiment of the sensor system 2, illustrated as a block diagram. The previously described explanations regarding the sensor system 2 and its components also apply in this example. In this embodiment, starting from FIG. 3, the sensor system 2 additionally has an optical source 62 for providing an optical signal in the receiver device 4.

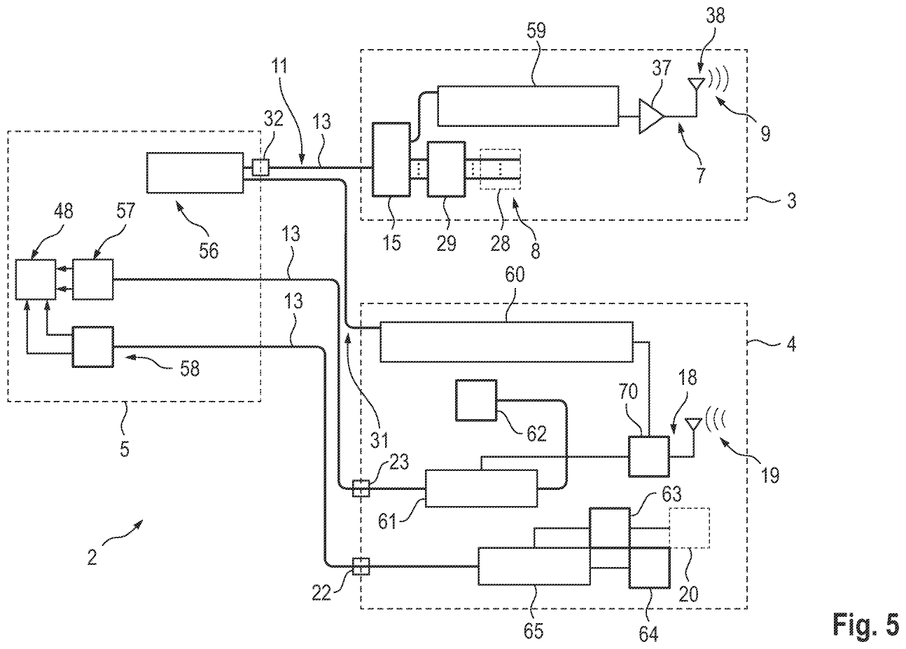

FIG. 5 shows by way of example another conceivable embodiment of the sensor system 2, illustrated as a block diagram. The previously described explanations regarding the sensor system 2 and its components also apply in this example. In this embodiment, starting from FIG. 4, the sensor system 2 additionally has a LIDAR-based receiver unit 63, a further optical source 64 and an opto-electronic converter unit 65 in the receiver device 4.

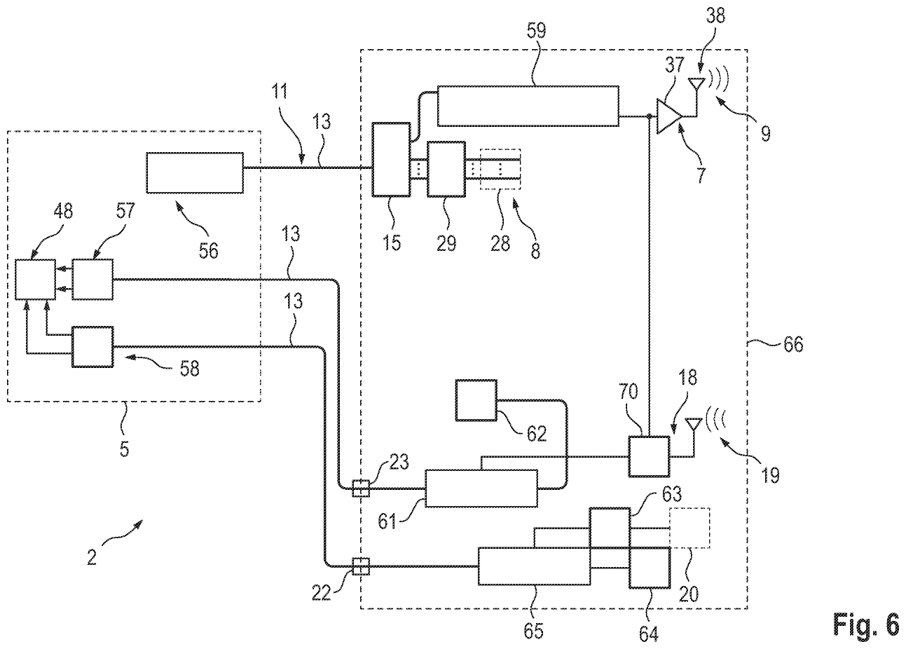

FIG. 6 shows by way of example another conceivable embodiment of the sensor system 2, illustrated as a block diagram. The previously described explanations regarding the sensor system 2 and its components also apply in this example. In this embodiment, starting from FIG. 5, the sensor system 2 has a combined transmitter/receiver device 66. The combined transmitter/receiver device 66 may have the transmitter device 3 and the receiver device 4.

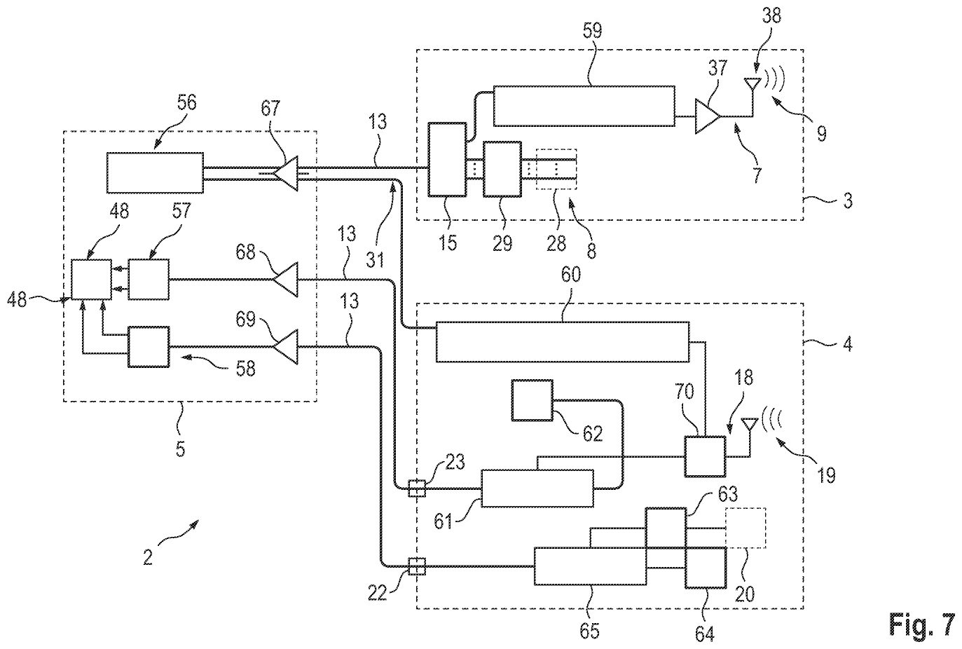

FIG. 7 shows by way of example another conceivable embodiment of the sensor system 2, illustrated as a block diagram. The previously described explanations regarding the sensor system 2 and its components also apply in this example. In this embodiment, starting from FIG. 5, the sensor system 2 has further amplifiers 67, 68, 69. The amplifier may be downstream of the optical signal generating device 56 so that the transmission signal 11 can be amplified. The amplifier 68 may be arranged between the second output 23 and the unit 57 so that the optical output signal 24 can be amplified. The amplifier 69 may be arranged between the first output 22 and the unit 58 so that the optical received signal 21 can be amplified.

### REFERENCE SIGN LIST

1 Motor vehicle
2 Sensor system
3 Transmitter device
4 Receiver device
5 Central computing device
6 Environment
7 Radio-based transmitter unit
8 Optical transmitter unit
9 Electrical emitted signal
10 Optical emitted signal
11 Optical transmission signal
12 Optical device
13 Fiber optics
14 Optical input
15 Interface unit
16, 17 First and second electrical output
18 Radio-based receiver unit
19 Electrical received signal
20 Optical receiver unit
21 Optical received signal
22, 23 First and second optical output
24 Optical emitted signal
25 Interface
26 Photodiode
27 Amplifier unit
28 Optical radiation unit
29 Phase shift module
30 Splitter
31 Return channel
32 Optical output
33 Modulating device
34 Carrier signal
35 Further splitter
36 Frequency multiplier
37 Power amplifier
38 Antenna
39, 40 Paths
41 Opto-electronic converter
42 Electrical LIDAR signal
43 Amplifier
44 Further Amplifier
45 IQ modulator
46 IQ generator
47 Additional processing path
48 Signal processing unit
49 Electrical radar signal
50 IQ mixer
51 Demodulating unit
52 Opto-electronic converter
53 Optical input
54 Mixer
55 Divider
56 Optical signal generating device
57 Unit
58 Unit
59 Opto-electronic converter unit
60 Opto-electronic converter unit
61 Opto-electronic converter unit
62 Optical source
63 Lidar-based receiver unit
64 Optical source
65 Opto-electronic converter unit
66 Combined transmitter/receiver device
67 Amplifier
68 Amplifier
69 Amplifier
70 Radar-based receiver unit
71 Mixer
72 Mixer
73 Carrier signal

1-10. (canceled)

11. A sensor system for surrounding area detection comprising:
an optical device for generating an optical transmission signal;
a transmitter device, the transmitter device comprising:
an optical input configured for receiving the optical transmission signal,
a radio-based transmitter unit configured for emitting an electrically-emitted signal, based on the optical transmission signal, and
an optical transmitter unit, the optical transmitter unit being configured for emitting an optical emitted signal based on the optical transmission signal,
a receiver device, the receiver device comprising:
an optical input configured for receiving the optical transmission signal,
a radio-based receiver unit for receiving an electrical received signal, and
an optical receiver unit (20) for receiving an optical received signal; and
a central computing device configured for processing emitted and/or received signals.

12. The sensor system according to claim 11,
wherein the radio-based transmitter unit is configured for
generating and emitting the electrical emitted signal in dependence on the optical transmission signal, or
generating and emitting the electrical emitted signal based on a manipulation of the optical transmission signal,
and wherein the optical transmitter unit is configured for
directly emitting the optical transmission signal as the optical emitted signal, or
converting the optical transmission signal to the optical emitted signal through manipulation and emitting it.

13. The sensor system according to claim 11, wherein
the receiver device comprises a first optical output and/or a first electrical output configured for providing the optical received signal to the central computing device,
and wherein the receiver device comprises a second optical output and/or a second electrical output configured for providing an optical output signal, which is based on the electrical received signal, to the central computing device.

14. The sensor system according to claim 11, wherein the receiver device comprises an optical and/or electrical amplifier and/or and optical demodulator and/or and electrical demodulator.

15. The sensor system according to claim 11, wherein the receiver device comprises an electrical return channel and/or an optical return channel, the receiver device being operatively coupled with the optical device via the electrical return channel and/or the optical return channel.

16. The sensor system according to claim 15, wherein
the optical return channel of the receiver device is fed by the optical transmission signal of the optical device and/or
the receiver device comprises an optical source operatively coupled to the optical return channel.

17. The sensor system according to claim 11, wherein
the central computing device comprises an interface with an external signal processing unit, and/or
a signal processing unit is integrated in the central computing device.

18. The sensor system according to claim 11, wherein
the transmitter device, the receiver device, the optical device, and the central computing device are configured to be physically and/or spatially separate with respect to each other, or
the transmitter device, the receiver device, the optical device, and the central computing device are configured together as a joint unit.

19. The sensor system according to claim 11, wherein the transmitter device, the receiver device, the optical device, and/or the central computing device are configured as at least partially physically and/or spatially separate entities with respect to each other.

20. A vehicle comprising a sensor system for surrounding area detection, the sensor system comprising:
an optical device for generating an optical transmission signal;
a transmitter device, the transmitter device comprising:
an optical input configured for receiving the optical transmission signal,
a radio-based transmitter unit configured for emitting an electrically-emitted signal, based on the optical transmission signal, and
an optical transmitter unit, the optical transmitter unit being configured for emitting an optical emitted signal based on the optical transmission signal,
a receiver device, the receiver device comprising:
an optical input configured for receiving the optical transmission signal,
a radio-based receiver unit for receiving an electrical received signal, and
an optical receiver unit (20) for receiving an optical received signal; and
a central computing device configured for processing emitted and/or received signals to function as a drive and evaluation unit of the sensor system.

21. The vehicle according to claim 20,
wherein the radio-based transmitter unit is configured for
generating and emitting the electrical emitted signal in dependence on the optical transmission signal, or
generating and emitting the electrical emitted signal based on a manipulation of the optical transmission signal,
and wherein the optical transmitter unit is configured for
directly emitting the optical transmission signal as the optical emitted signal, or
converting the optical transmission signal to the optical emitted signal through manipulation and emitting it.

22. The vehicle according to claim 20, wherein
the receiver device comprises a first optical output and/or a first electrical output configured for providing the optical received signal to the central computing device,
and wherein the receiver device comprises a second optical output and/or a second electrical output configured for providing an optical output signal, which is based on the electrical received signal, to the central computing device.

23. The vehicle according to claim 20, wherein the receiver device comprises an optical and/or electrical amplifier and/or and optical demodulator and/or and electrical demodulator.

24. The vehicle according to claim 20, wherein the receiver device comprises an electrical return channel and/or an optical return channel, the receiver device being operatively coupled with the optical device via the electrical return channel and/or the optical return channel.

25. The vehicle according to claim 24, wherein
the optical return channel of the receiver device is fed by the optical transmission signal of the optical device and/or
the receiver device comprises an optical source operatively coupled to the optical return channel.

26. The vehicle according to claim 20, wherein
the central computing device comprises an interface with an external signal processing unit, and/or
a signal processing unit is integrated in the central computing device.

27. The vehicle according to claim 20, wherein
the transmitter device, the receiver device, the optical device, and the central computing device are configured to be physically and/or spatially separate with respect to each other, or
the transmitter device, the receiver device, the optical device, and the central computing device are configured together as a joint unit.

28. The vehicle according to claim 20, wherein the transmitter device, the receiver device, the optical device, and/or the central computing device are configured as at least partially physically and/or spatially separate entities with respect to each other.

29. A method for operating a sensor system for surrounding area detection comprising:
generating an optical transmission signal via an optical device;
receiving the optical transmission signal in an optical input of a transmitter device;
emitting an electrically-emitted signal via a radio-based transmitter unit of the transmitter device, based on the optical transmission signal emitting an optical emitted signal based on the optical transmission signal, via an optical transmitter unit of the transmitter device;
receiving the optical transmission signal via an optical input of a receiver device;
receiving an electrical received signal via a radio-based receiver unit of the receiver device;
receiving an optical received signal via a radio-based receiver unit of the receiver device; and
processing the emitted and/or received signals via a central computing device.
